(19) United States
(12) Patent Application Publication
(10) Pub. No.: US 2025/0346763 A1
(43) Pub. Date: Nov. 13, 2025

(54) ANTI-AGING ADDITIVES FOR ASPHALT BINDERS AND ROOFING MATERIALS

(71) Applicant: Ergon, Inc., Jackson, MS (US)

(72) Inventors: Ken Cooley, Hattiesburg, MS (US); Jerry Johnson, Hattiesburg, MS (US); Codrin Daranga, Madison, MS (US); Robert Dwayne Johnson, Brandon, MS (US)

(21) Appl. No.: 18/262,324

(22) PCT Filed: Jan. 20, 2022
(86) PCT No.: PCT/US2022/013168

§ 371 Date: Jul. 20, 2023

Related U.S. Application Data
(60) Provisional application No. 63/139,501, filed on Jan. 20, 2021.

(51) Int. Cl. C08L 95/00; C09D 7/48; C09D 7/65; C09D 195/00; C09J 11/08; C09J 195/00; E04D 11/00

(52) U.S. Cl. CPC C08L 95/00; C09D 7/48; C09D 7/65; C09D 195/00; C09J 11/08; C09J 195/00; E04D 11/00; C08L 2201/08; C08L 2207/22; C08L 2555/22; C08L 2555/80

(57) ABSTRACT

An asphalt binder composition for use in asphalt-containing materials that includes at least one of a virgin asphalt binder, an air-blown virgin asphalt binder, or a reclaimed asphalt binder material, and an anti-aging agent that is a reaction product of ingredients including (i) a first material including a compound containing one or more carbonyl groups and (ii) a second material that reacts with the one or more carbonyl groups of the first material and adds hydroxyl groups to the reaction product, where the anti-aging agent has a hydroxyl value of greater than about 25 mg KOH/g.

This application is a national stage filing under 35 U.S.C. § 371 of International Application No. PCT/US2022/013168 filed Jan. 20, 2022, which claims priority under 35 U.S.C. § 119 to U.S. Provisional Application No. 63/139,501 filed Jan. 20, 2021, the disclosures of both of which are incorporated herein by reference.

### BACKGROUND

Asphalt materials (e.g., asphalt pavement and asphalt shingles) are some of the most recycled materials in the world, finding uses when recycled in shoulders of paved surfaces and bridge abutments, as a gravel substitute on unpaved roads, and as a replacement for virgin asphalt binder in new and recycled pavement mixtures. Recycling asphalt poses certain challenges because asphalt deteriorates with time, loses its flexibility, becomes oxidized and brittle, and tends to crack, particularly under stress or at low temperatures. These effects are primarily due to aging of the organic components of the asphalt binder, e.g., the bitumen-containing binder, particularly upon exposure to weather. The aged asphalt binder is also highly viscous. Consequently, reclaimed asphalt materials often have different properties than virgin asphalt binder and are difficult to process. For paving and roofing applications, the material composition used to make either a road or a roof determines, to a great extent, the performance of the resultant paving or roofing material (e.g., aging, cracking, blistering, moisture resistance, wear resistance, algae resistance, flexibility/pliability, and adhesive character.).

### SUMMARY

Disclosed are compositions and methods that may retard, reduce, or otherwise overcome the effects of aging in virgin or aged asphalt materials to preserve or rejuvenate some or all the original properties of the virgin asphalt binder originally used. In some embodiments, the disclosed compositions and methods may alter the aging rate and performance properties of the total asphalt binder present in an asphalt binder mixture containing virgin asphalt and reclaimed asphalt binder material comprising asphalt pavement (RAP), asphalt shingles (RAS), or both.

The disclosed asphalt binder compositions or mixtures may be used in several applications including, but not limited to, in production of moisture barrier and waterproofing films, underlayment, asphalt-based adhesives and sealants, roofing materials (such as roofing shingles, roll roofing and built-up roofing), asphalt pavement, asphalt pavement restoration or preservation material, or the like. Typically, roofing materials include a substrate such as a glass fiber mat, an asphalt-based coating which saturates the substrate and coats the top and bottom, and a layer of granules embedded in the top coating. The asphalt coating may also contain a filler such as ground limestone. Roofing shingles can also have a coating on their underside containing back dust material such as silica sand to prevent the shingles from sticking together when in a bundle. Typically, paving materials include a mixture of the asphalt binder, aggregate particles and other optional additives.

The disclosed compositions and methods use modified asphalt anti-aging agents that are altered to contain high levels of free hydroxyl groups. Such modified anti-aging agents may improve the processing and performance properties within virgin, reclaimed, and highly oxidized asphalt binder materials. Additionally, incorporation of such anti-aging agents may slow the detrimental effects of aging of virgin asphalt binder, allow use of higher amounts of recycled asphalt materials, or both.

In some embodiments, this disclosure describes an asphalt binder composition for use in producing a moisture barrier or waterproof film, an underlayment, an asphalt-based adhesive or sealant, a roofing material, asphalt pavement, or asphalt pavement restoration or preservation material. The asphalt binder composition may include an asphalt binder containing at least one of a virgin asphalt binder, an air-blown virgin asphalt binder, a reclaimed asphalt binder material comprising asphalt pavement (RAP), or a reclaimed asphalt binder material including asphalt shingles (RAS). The composition also includes and an anti-aging agent that is a reaction product of ingredients including (i) a first material including a compound containing one or more carbonyl groups and (ii) a second material that reacts with the one or more carbonyl groups of the first material and adds hydroxyl groups to the reaction product, where the anti-aging agent has a hydroxyl value of greater than about 25 mg KOH/g.

In another embodiment, this disclosure describes an asphalt-containing material that includes an asphalt binder composition having an asphalt binder containing at least one of a virgin asphalt binder, an air-blown virgin asphalt binder, a reclaimed asphalt binder material comprising RAP, or a reclaimed asphalt binder material comprising RAS. The asphalt binder composition also includes an anti-aging agent that is a reaction product of ingredients including (i) a first material including a compound containing one or more carbonyl groups and (ii) a second material that reacts with the one or more carbonyl groups of the first material and adds hydroxyl groups to the reaction product, where the anti-aging agent has a hydroxyl value of greater than about 25 mg KOH/g. Examples of the asphalt-containing material may include, but are not limited to, moisture barrier or waterproof films, underlayments, asphalt-based adhesives or sealants, roofing materials, asphalt pavement, or asphalt pavement restoration or preservation materials.

In another embodiment, this disclosure describes a method for slowing the aging effects of an asphalt-containing material that includes forming an asphalt binder composition by adding an anti-aging agent to an asphalt binder, where the asphalt binder includes at least one of a virgin asphalt binder, an air-blown virgin asphalt binder, a reclaimed asphalt binder material comprising RAP, or a reclaimed asphalt binder material comprising RAS, and where the anti-aging agent is a reaction product of ingredients including (i) a first material including a compound containing one or more carbonyl groups and (ii) a second material that reacts with the one or more carbonyl groups of the first material and adds hydroxyl groups to the reaction product, wherein the anti-aging agent has a hydroxyl value of greater than about 25 mg KOH/g.

In another embodiment, this disclosure describes a method for of making asphalt-containing materials such as moisture barrier or waterproof films, underlayments, asphalt-based adhesives or sealants, roofing materials, or asphalt pavement. The method includes adding an anti-aging agent as described herein to an asphalt binder composition to form a coating composition, where the coating composition includes a virgin asphalt binder, oxidized (e.g., air blown) asphalt binder, aged asphalt binder such as RAP or RAS, or combinations thereof.

In another embodiment, this disclosure describes a roofing material comprising a coated roofing substrate, wherein the coating or saturate includes an asphalt binder composition containing an asphalt binder and an anti-aging agent that is a reaction product of ingredients including (i) a first material including a compound containing one or more carbonyl groups and (ii) a second material that reacts with the one or more carbonyl groups of the first material and adds hydroxyl groups to the reaction product, where the anti-aging agent has a hydroxyl value of greater than about 25 mg KOH/g.

The disclosed anti-aging agents are useful to retard or slow the aging rate, or to restore or renew aged asphalt binder to provide some or all of the original properties of virgin oxidized or air blown asphalt or virgin asphalt binder to be used in roofing materials,

In some embodiments, this disclosure describes an asphalt binder composition for use in producing a moisture barrier, a waterproof film, an underlayment, an asphalt-based adhesive or sealants, a roofing material, asphalt pavement, or an asphalt pavement restoration or preservation material. The asphalt binder composition includes an asphalt binder including at least one of a virgin asphalt binder, an air-blown virgin asphalt binder, or a reclaimed asphalt binder material and further includes an anti-aging agent derived from reacting an asphalt additive with one or more polyols or amine alcohols to increase a hydroxyl value of the additive, wherein the anti-aging agent provides a less negative ΔTc in aged asphalt containing the modified anti-aging agent after 40 hours of PAV aging at 100 degrees Celsius compared to a similarly-aged asphalt binder with the unmodified asphalt additive. In some such examples, the anti-aging agent may have a hydroxyl value of greater than about 25 mg KOH/g, greater than 35 mg KOH/g, greater than 40 mg KOH/g, or greater than 50 mg KOH/g.

The above summary of this disclosure is not intended to describe each embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### Abbreviations, Acronyms & Definitions

“Aged” refers to asphalt binder that is present in or is recovered from reclaimed asphalt. Aged asphalt binder has high viscosity compared with that of virgin asphalt or virgin asphalt binder of the same grade as a result of aging and exposure to outdoor weather. The term “aged” can also include asphalt binder that has been artificially aged via an air-blown process or using the laboratory aging test methods described herein (e.g., RTFO and PAV discussed further below). Aged asphalt binder may be brittle and may have a higher stiffness or a higher softening point relative to the virgin asphalt binder.

“Aggregate” refers to particulate mineral material such as limestone, granite, trap rock, gravel, crushed gravel sand, crushed stone, crushed rock, roofing granules, and minerals added to asphalt binder and useful in certain applications such as creating roofing materials or in pavement applications.

“Anti-aging agent” refers to a material that can be combined with an aged asphalt binder or a virgin asphalt binder to retard the rate of aging of asphalt-based materials or asphalt binder, or to restore or renew the aged asphalt-based material or aged asphalt binder to provide some or all of the original properties of virgin asphalt or virgin asphalt binder. In some embodiments, the disclosed anti-aging agents may include novel compounds or materials known by those in the industry that undergo reaction to satisfy the criteria disclosed herein (e.g., increased hydroxyl value). The effectiveness of the material as an anti-aging agent may be examined by comparing the ΔTc value of an asphalt binder mixture containing the anti-aging agent after 40 hours of PAV aging at 100 degrees Celsius compared to a similarly-aged asphalt binder without the anti-aging agent or, in the examples where the starting material has undergone the disclosed modification to increase its hydroxyl value, with the unmodified material.

“Asphalt pavement” or “asphalt pavement mixture” refers to an asphalt binder and aggregate and optionally other components that are suitable for mixing with aggregate and asphalt binder.

“Asphalt binder” refers to a highly viscous liquid or semi-solid form of petroleum. Depending on the jurisdiction, the term “binder” may refer to “asphalt” and “asphalt binder” or “bitumen.” Bitumen refers to a class of black or dark-colored (solid, semisolid, or viscous) cementitious substances, natural or manufactured, composed principally of high molecular weight hydrocarbons, of which asphalts, tars, pitches, and asphaltenes are typical. The term “asphalt binder” may be used interchangeably with the terms “binder,” “asphalt,” and “bitumen” within this disclosure.

“M-critical” or “Creep critical” grade refers to the low temperature relaxation grade of an asphalt binder. The creep critical temperature is the temperature at which the slope of the flexural creep stiffness versus creep time according to ASTM D6648 has an absolute value of 0.300. Alternatively, the stiffness and creep critical temperatures can be determined from a 4 mm Dynamic Shear Rheometer (DSR) test or Bending Beam Rheometer (BBR) test.

“Modified anti-aging agent” is used to refer materials that have undergone the disclosed process to increase the hydroxyl value of the material (e.g., increase the hydroxyl value to greater than about 25 mg KOH/g). In some embodiments, the modified anti-aging agents may include novel compounds not previously used in asphalt binder mixtures that have undergone the disclosed process to provide or increase the hydroxyl value and anti-aging properties. In other embodiments, the modified anti-aging agents may include the modified version of conventional or commercially available anti-aging agents or asphalt additives that have undergone the disclosed process to provide or increase the hydroxyl value and produce or increase their anti-aging properties. Reference to a “modified anti-aging agent” accordingly does not imply that the starting material must be a recognized or commercially available anti-aging agent or asphalt additive prior to undergoing the disclosed modification to increase the hydroxyl value of the material such that the agent reduces the aging rate of an asphalt binder.

“Neat” or “Virgin” binders are asphalt binders not yet used in or recycled from asphalt materials (e.g., asphalt pavement or asphalt shingles), and can include Performance Grade asphalt binders.

“Partial ester” refers to a material that contains ester linkages and also contains either or both of unreacted carboxyl groups and unreacted hydroxyl groups.

“Partial esterification” refers to an ester-forming reaction that produces one or more partial esters.

“PAV” refers to a Pressurized Aging Vessel. The PAV is used to simulate accelerated aging of asphalt binder as described in ASTM D6521-19a, Standard Practice for Accelerated Aging of Asphalt Binder Using a Pressurized Aging Vessel (PAV).

“Reclaimed asphalt” and “recycled asphalt” refer to RAP, RAS, and reclaimed asphalt binder from old pavements, shingle manufacturing scrap, roofing felt, and other products or applications containing asphalt binder that are recycled.

“Reclaimed asphalt pavement” and “RAP” refer to asphalt that has been removed or excavated from a previously used asphalt pavement/road or other similar structure, and processed for reuse by any of a variety of well-known methods, including milling, ripping, breaking, crushing, or pulverizing.

“Reclaimed asphalt shingles” and “RAS” refer to shingles from sources including roof tear-off, manufacture's waste asphalt shingles and post-consumer waste.

“Roofing asphalt binder” or “coating asphalt binder” refers to asphalt binder that is suitable to make roofing materials as defined by ASTM D 3462: a softening point minimum of 88° C. (190° F.) to 113° C. (235° F.) and a minimum penetration of 15 dmm at 25° C. (77° F.).

“Roofing fillers” or “fillers” refer to material such as minerals that are used in the manufacture of roofing asphalt binders. The filler materials typically have a particle size of 100-400 mesh and range from 1 to 80 per by weight of the total roofing asphalt binder composition.

“Roofing granules” or “granules” refer to materials such as minerals that are applied atop a roofing shingle. The granules typically have a particle size of 8-40 mesh.

“Roofing materials” refers to materials containing asphalt binder and include roofing shingles, roll roofing, built-up roofing, post-consumer waste (e.g., tear-off shingles) or manufacture's waste shingles, shingle manufacturing scrap, roofing felt, and the like.

“RTFO” refers to a Rolling Thin Film Oven. The RFTO is used for simulating the short-term aging of asphalt binders as described in ASTM D2872-19, Standard Test Method for Effect of Heat and Air on a Moving Film of Asphalt (Rolling Thin-Film Oven Test).

“S-Critical” or “stiffness critical” grade refers to the low temperature stiffness grade of an asphalt binder. The stiffness critical temperature is the temperature at which an asphalt binder tested according to ASTM D6648-08(2016) has a flexural creep stiffness value of 300 MPa or as determined by either the BBR test or 4 mm DSR test as described in ΔTc.

“SHRP” refers to the Strategic Highway Research Program and its performance grade (PG) specifications.

“Softening agents” refers to low viscosity additives that ease (or facilitate) the mixing and incorporation of a recycled asphalt binder into virgin asphalt binder during an asphalt-based material production process.

“ΔTc” refers to the value obtained when the low temperature creep or m-value critical temperature is subtracted from the low temperature stiffness critical temperature. To determine the ΔTc parameter, a 4 mm DSR test procedure and data analysis methodology may be used. Example DSR test procedures and methodology are also disclosed in Published International Application Nos. WO 2017/027096 A2, WO 2017/213692 A1 and WO 2017/213693 A9, the disclosures of each of which are incorporated herein by reference in their entirety. The 4 mm DSR test and analysis procedures are also described by Sui, C., Farrar, M., Tuminello, W., Turner, T., A New Technique for Measuring low-temperature Properties of Asphalt Binders with Small Amounts of Material, Transportation Research Record: No 1681, TRB 2010. See also Sui, C., Farrar, M. J., Hamsberger, P. M., Tuminello, W. H., Turner, T. F., New Low Temperature Performance Grading Method Using 4 mm Parallel Plates on a Dynamic Shear Rheometer. TRB Preprint CD, 2011, and Farrar, M., et al, (2012), Thin Film Oxidative Aging and Low Temperature Performance Grading Using Small Plate Dynamic Shear Rheometry: An Alternative to Standard RTFO, PAV and BBR Eurasphalt & Eurobitune 5th E&E Congress-2012 Istanbul (pp. Paper O5ee-467). Istanbul: Foundation Eurasphalt. The ΔTc parameter can also be determined using a BBR test procedure based on AASHTO T313 (2^{nd} edition 2019) or ASTM D6648-08(2016). When the BBR test procedure is used the test should be conducted at a sufficient number of temperatures such that results for the Stiffness failure criteria of 300 MPa and Creep or m-value failure criteria of 0.300 are obtained with one result being below the failure criteria and one result being above the failure criteria. In some instances, for asphalt binders with ΔTc values less than −5° C. this can require performing the BBR test at three or more test temperatures. ΔTc values calculated from data when the BBR criteria requirements referred to above are not met may not be accurate.

All weights, parts and percentages are based on weight unless otherwise specified.

### DETAILED DESCRIPTION

In one aspect, the present disclosure provides an asphalt binder mixture that includes an asphalt binder and an anti-aging agent that is a reaction product of ingredients including (i) a first material including a compound containing one or more carbonyl groups and (ii) a second material that reacts with the one or more carbonyl groups of the first material and adds hydroxyl groups to the reaction product, wherein the anti-aging agent has a hydroxyl value of greater than about 25 mg KOH/g. The asphalt binder may include a virgin asphalt binder, oxidized or aged (e.g., air blown) asphalt binder, reclaimed asphalt binder material such as RAP or RAS, or combinations thereof. The disclosed anti-aging agents are shown to slow the rate of aging in asphalt roofing binders. Applicants have previously shown that such modified anti-aging agents can retard, reduce, or otherwise overcome some of the effects of asphalt pavement aging so as to preserve or retain some or all of the original properties of virgin asphalt binder, see Published International Application WO 2021/011677 A2, the disclosure of which is incorporated herein by reference in its entirety. The disclosed anti-aging agents possessing increased hydroxyl values were used with asphalt binders containing reclaimed or recycled materials such as recycled RAP, recycled RAS, or combinations of both to improve the aging properties of the resultant asphalt binder mixture.

As asphalt-based materials age, the asphalt binder within the material oxidizes which negatively impacts the properties of the asphalt materials. For example, aged asphalt binder will often become more brittle particularly at low temperatures causing the asphalt material to crack or not function as intended. Different parameters are used to measure how effectively different asphalt binders respond to aging or how effectively different components will affect the asphalt binder's response to aging. One particularly useful parameter for assessing an asphalt binder's aging property is knowing the mixture's Delta Tc (ΔTc). The ΔTc can be calculated by measuring and subtracting the m-critical temperature from the S-critical temperature (e.g., ΔTc=T_{c,s (60 s)}−T_{c,m(60 s)}) of the material. As a general precaution and historical note for those that review prior literature, some of those prior references examining ΔTc may switch the order of subtraction leading to a change in the sign of the calculated ΔTc. For example, the original report from Anderson, R. M, King, G. N., Hanson, D.I., Blankenship, P. B “Evaluation of the Relationship between Asphalt Binder Properties and Non-Load Related Cracking,” Association of Asphalt Paving Technologists, Volume 80, pp 615-663 (2011) showed, based on recovered binder data from field cores, that ΔTc could be used to identify when an asphalt pavement reached a point where there was a danger of non-load related mixture cracking and also when potential failure limit had been reached. However, in that research the authors subtracted the S-critical temperature from the creep or m-critical temperature and therefore binders with poor performance properties had calculated ΔTc values that were positive.

Since approximately 2011 industry researchers have agreed to reverse the order of subtraction and therefore when the m-critical temperature is subtracted from the stiffness critical temperature binders exhibiting poor performance properties calculate to ΔTc values that are negative. The industry generally agreed that to have poor performing binders become more negative as performance decreased seemed to be more intuitive. Therefore, today in the industry and as used in the application, a ΔTc warning limit value is −3° C. and a potential failure value is −5° C.

The ΔTc parameter also may be used to assess the impact of aging on asphalt binder properties such as the relaxation properties of the asphalt binder (e.g., the property referred to as “low temperature creep grade”). In field test projects subjected to 40 hours of PAV aging, the ΔTc values showed a correlation to distress in the asphalt material (e.g., asphalt pavement) related to non-load related block cracking, especially top down fatigue cracking which is generally considered to result from loss of binder relaxation at the bituminous mixture surface. Changes in m-critical temperature can also be used to quantify the rate or extent to which an oxidized asphalt binder's level of embrittlement is increasing. Likewise, determination of the S-critical temperature of oxidized asphalt binders may be used as a means of identifying the changes in the low temperature stiffness properties in the oxidized asphalt binder mixtures.

It is therefore desirable to obtain asphalt binder mixtures that have a reduced susceptibility to the development of excessively negative ΔTc values with age. To reduce or retard the impact of asphalt binder aging on the long-range performance of asphalt binder mixtures, many materials have been investigated with varying degrees of success. One class of materials are referred to as anti-aging agents or rejuvenators. These materials are often marketed with a stated goal of reversing the aging that has taken place in recycled raw materials such as RAP and RAS or slowing the aging effect in virgin binder. In some embodiments, anti-aging agents may help restore the rheological properties of aged asphalt binders, thereby allowing a greater percentage of the asphalt binder mixture to be formed of RAP or RAS materials.

One group of anti-aging agents that have been explored include sterols. Sterols, also known as steroid alcohols, are a group of organic molecules often derived from natural sources such as plants, animals, fungi, or bacteria. Sterols have been found to help increase the ΔTc of aging binders thereby allowing the binder to retain its performance properties over a longer lifespan of the material. While sterols have shown promise as asphalt anti-aging agents, the costs associated with producing such materials can be comparatively high.

Another group of asphalt anti-aging agents include those acquired from bio-based sources including, for example, castor, cashew nut shell, rapeseed, soybean, sunflower, tall, vegetable, and other plant-based oils. Some of these materials can be relatively inexpensive compared to sterols and easy to acquire, however many of these materials have been found to be poor anti-aging agents or suffer from other drawbacks. For example, vegetable oil has been found to help soften binders but is prone to leaching from rejuvenated asphalt causing the binder to resort back to its aged condition and can lead to rutting in the asphalt pavement over time.

Published International Application WO 2013/163463 A1 (Grady et al to Arizona Chemical, or “Grady”) entitled REJUVENATION OF RECLAIMED ASPHALT, described the use of ester-functional anti-aging agents such as those derived from tall oil in the production of asphalt pavement. Grady stated that by incorporating ester-functional groups into the anti-aging agents the glass-transition onset temperature of the binder may be reduced thereby improving the low-temperature and fatigue cracking resistance of the asphalt along with other properties for asphalt pavement. However, we have found that the high ester-functional tall oil derivatives disclosed by Grady have poor effects on the asphalt binder and tend to exhibit worse performance characteristics over time than the unmodified tall oil materials from which the high ester-functional derivatives are prepared. We believe the low performance properties of the derivatives disclosed by Grady are due to the low hydroxyl content (e.g., low hydroxyl values) in the materials produced under the reaction parameters disclosed by Grady.

The presently disclosed anti-aging agents (e.g., those possessing increased hydroxyl values) may be derived from starting materials that include carbonyl-containing compounds such as tall oil, other plant based materials (e.g., raw materials or extracts sourced from plants), or other asphalt additives that undergo reaction with a second material capable of reacting with the carbonyl groups to add hydroxyl groups to the reaction product to result in a hydroxyl value of greater than about 25 mg KOH/g. Without being bound by theory, it is believed that increasing the number of free hydroxyl groups in such agents, for example by increasing the number of free hydroxyl groups in a tall oil material, increases the polarity of such materials, making them more compatible and thus better suited to help soften and mix with the aging asphalt binders and other materials. For example, asphalt binders are a complex mixture of materials and while the mechanisms of aging are not completely understood, due to oxidation there is a general shift in the relative amount of aliphatic groups or segments in the binder materials toward more polar structures including, for example, the formation of ether, peroxide, and alcohol groups within the aging binder materials. This shift causes the binder to become stiffer and more polar with age. We have found that increasing the polarity of starting materials such as tall oil or other carbonyl-containing agents by increasing the relative number of free hydroxyl groups within such compounds can significantly increase their efficacy as anti-aging agents for asphalt binders. The resultant anti-aging agents appear to be more compatible with the aged asphalt binders and may help solvate and soften the aged asphalt binder to both decrease the m-critical and S-critical grades of the material as well as increase the ΔTc of the asphalt binder mixture. The modified anti-aging agent may help, in part, by softening the aged asphalt binder to produce a workable asphalt binder mixture that in turn allows the mixture to be easily prepared, paved, and compacted. Additionally, or alternatively, the modified anti-aging agents may help slow or impede the aging effects on virgin asphalt binder allowing them to be used for a longer service period.

The disclosed modified anti-aging agents may alter (e.g., reduce or retard) an asphalt binder aging rate, or can rejuvenate, restore or renew an aged or recycled asphalt binder to provide some or all of the properties of a virgin asphalt binder. The disclosed asphalt binder compositions or mixtures containing the disclosed anti-aging agents having increased hydroxyl values also may improve the processing and performance properties within virgin, reclaimed, and highly oxidized asphalts, and thereby help preserve, recycle and reuse asphalt sources or asphalt binders. In some embodiments, the disclosed anti-aging agents can alter or improve the physical and rheological characteristics such as stiffness, effective temperature range, and low temperature properties of an asphalt binder mixture. Such asphalt binder mixtures containing the disclosed anti-aging agents may be useful in producing a variety of asphalt-based materials including, but not limited to, moisture barrier and waterproofing films, underlayment, asphalt-based adhesives and sealants, roofing materials (such as roofing shingles, roll roofing and built-up roofing), asphalt pavement, asphalt pavement restoration or preservation material, or the like.

Starting materials that may be used to derive the disclosed anti-aging agents include one or more compounds containing accessible or available carbonyl groups capable of reacting with a second material (e.g., polyols or amine alcohols) to increase the number of free hydroxyl groups in the reaction product such that the hydroxyl value of the resultant product is greater than about 25 mg KOH/g. Such starting materials may include those containing carboxylic acid groups, ester groups, amine groups, imide groups, or combinations thereof that react with polyols (e.g., to form ester linkages) or react with amine groups of an amine alcohol (e.g., to form amide linkages). Example carbonyl-containing compounds may include, but are not limited to, glycerides and triglycerides such as various vegetable and natural oils, various tall oils, vegetable oils, rosins, pitch, wood-chemistry materials, engine oils, recycled oils, fatty acids, mono acids, di-acids, tri-acids, C₁-C₃₆ carboxylic acids, esters, keto acids, oxo-carboxylic acids, polyesters, anhydrides, compounds containing both anhydride and carboxylic acid groups, various amides and imides, compounds that contain two or more groups of the above referenced types, blends thereof, and the like. Additionally, or alternatively, the starting material may include mixtures or blends of different carbonyl-containing compounds, and may additionally or alternatively include co-reactants that do not contain a carbonyl group but which may participate in the reaction. While the below examples primarily focus on tall oil as the starting material (e.g., first material), the concepts disclosed herein are not limited to tall oil.

Preferred starting materials include those with one or more reactive carbonyl groups (e.g., carboxylic acids, esters, amides, imides, and the like) and which are relatively inexpensive to acquire. Such preferred starting materials may include, but are not limited to, plant based materials such as castor, cashew nut shell, cottonseed, corn, peanut, rapeseed, rice bran, safflower, sarsaparilla root, soybean, sunflower, vegetable, wheat germ and other plant based oils; recycled oils; rosins and rosin acids; fatty acids; mixtures thereof and the like. Additionally, or alternatively, the starting materials may include one or more coal or petroleum-based materials including, but not limited to, coal tar pitch, coal extracts, petroleum sourced reactants, derivatives or mixtures thereof, and the like. The disclosed modification techniques also may be applied to other commercially available asphalt additives including conventional anti-aging agents and to commercially available asphalt additives when such agents and additives are capable of reacting with one or more hydroxyl groups of a polyol or the amine group of an amine alcohol to provide a sufficiently hydroxyl-functional modified anti-aging agent or additive that will impart improved anti-aging properties to an asphalt binder mixture. In some embodiments, the available carbonyl groups in the starting material may be increased through an oxygenation process or other synthesis technique.

The relative number of free hydroxyl groups in the starting material may be increased using a variety of techniques. In some embodiments, the number of free hydroxyl groups may be increased by reacting carbonyl-containing starting materials with one or more polyols or amine alcohols while controlling the reaction conditions and stoichiometric ratios of the materials to favor the addition of such polyols or amine alcohols without unduly consuming or exhausting the available hydroxyl groups. Additionally, or alternatively, the hydroxyl value of the starting materials may be increased through an alcoholysis-transesterification reaction or by using a different reaction mechanism, catalyst, or with different reactants. A goal in each such instance is to accomplish partial esterification while leaving unreacted (viz., free) hydroxyl groups in the reaction product.

The availability of free hydroxyl groups may be measured in terms of the hydroxyl value of the resultant compounds, for example by using ASTM method D1957-86 (1995). The disclosed anti-aging agents should have a resultant hydroxyl value of greater than about 25 mg KOH/g, more preferably at least about 35 mg KOH/g, and most preferably at least about 50 mg KOH/g after reaction with the polyols or amine alcohols. For comparison, commercially available fatty acid esters and rosin acid esters typically have hydroxyl values that range from 0-5 mg KOH/g and 5-12 mg/KOH/g. Crude tall oil has a hydroxyl value on the order of about 1 mg KOH/g.

The final hydroxyl value may be adjusted as needed to even higher or lower values to obtain the desired adjustment to ΔTc depending on the end need for the disclosed binder mixtures. In some embodiments, the disclosed anti-aging agents have a hydroxyl value that provides a less negative ΔTc in aged asphalt containing the anti-aging agent after 40 hours of PAV aging at 100 degrees Celsius compared to a similarly-aged binder with the unmodified agent.

In some embodiments, the final hydroxyl value may, depending on the acid value of the starting material, be adjusted based on the number of acid groups available within the starting materials (e.g., first material), number of hydroxyl groups within the second material (e.g., the selected polyols or amine alcohols), the initial polarity of the reactants, and the like. The disclosed modification process may in some embodiments reduce the acid number of the starting material. For example, reacting fatty acid materials with one or more polyols or amine alcohols may cause at least some of the carboxyl groups of the fatty acids to react with the polyols (e.g., through esterification) or amine alcohols (e.g., through amide formation) and lower the resultant acid number of the materials. In some embodiments, the disclosed anti-aging agents may have an acid value of less than about 100, less than about 70, less than about 30, or even lower values. In some embodiments, the acid value of the starting materials may be initially increased to provide more reactive acid groups within the starting material for bonding with the disclosed polyols or amine alcohols. The acid values of the starting materials may be increased using a variety of techniques. For example, the starting materials include or may be reacted with an acid or anhydride (e.g., acrylic acid, adipic acid, fumaric acid, maleic acid, maleic anhydride, succinic acid, neodecanoic acid, other diacids, and the like) to increase the number of carboxylic acid groups in the starting molecule through, for example, Diels-Alder addition or ester addition. The increase in available carboxylic acid groups may allow for additional bonding between the second materials (e.g., polyols or amine alcohols) used to increase the hydroxyl value of the resultant product. Additionally, or alternatively, at least some of the available carboxylic acid groups of the starting materials may remain within the resultant modified anti-aging agent to, for example, serve other functions in the asphalt binder mixtures. For example, the carboxylic acid groups may help the asphalt binder mix with and bond to the aggregate.

In some embodiments, the disclosed modification process may include an alcoholysis-transesterification process to increase the hydroxyl value. For example, a starting material that includes one or more ester linkages (e.g., soybean oil or other plant-based oil) may be reacted with a polyol using a transesterification catalyst. The polyol, having more than two hydroxyl groups, can replace an organic group at the ester linkage. One of the hydroxyl groups of the polyol will be donated to the removed organic group to form a new alcohol which may be left in the reaction product of removed. The polyol (absent that hydroxyl group) will form a new ester linkage with the de-esterified carbonyl group (absent the removed organic group) in the modified starting material and will provide one or more additional free hydroxyl groups.

In some embodiments, the starting material may be a crude or refined material. For example, the starting material may be a low cost, pure or impure, side product or waste stream from the manufacture of a higher value product.

In some embodiments, the disclosed anti-aging agents may include modified tall oil. Conventional tall oil is a byproduct of paper milling and includes a complex mixture of different compounds including various rosin and fatty acid materials including rosin acids such as abietic acid and its isomers; various fatty acids including palmitic acid, oleic acid, and linoleic acids, fatty alcohols; sterols; and other alkyl hydrocarbon derivatives. The composition of tall oil varies a great deal depending on supply source, level of refinement, and the like. A typical technique of quantifying the quality or refinement of tall oil is to refer to the acid number, level of fatty acid content, or both. Conventionally tall oil can be purchased with acid values ranging from about 100-200, or from about 125-165. Tall oil is available in many forms including for example crude tall oil and distilled or refined crude tall oil. Distillation of crude tall oil provides various isolated forms of fatty acids including highly saturated and volatile long-chain fatty acids known as tall oil heads, tall oil fatty acids including C₅-C₂₀ fatty acids having varying degrees of unsaturation, and tall oil rosins or pitch which include largely C₁₈-C₂₀ tricyclic monocarboxylic acids. Commercially distilled tall oil includes a mixture of mostly tall oil fatty acid and a varying proportion of tall oil rosin. In some embodiments, the disclosed anti-aging agents may be derived from crude tall oil, distilled tall oil, tall oil head, tall oil pitch, or a mixture thereof.

The hydroxyl value of tall oil, in particular the hydroxyl value of such fatty acids, rosin acids, and similar compounds present in tall oil, may be increased by reacting tall oil under relatively low temperatures with polyols or amine alcohols. The hydroxyl groups or amine groups can react with one or more carbonyl groups (e.g., carboxylic acid groups) of the fatty acid and rosin acids of tall oil to form an ester or amide linkage. While reaction conditions, times, and stoichiometry may be unique to the individual carbonyls and polyols used in the reaction, the reaction kinetics can be controlled to favor the addition of such polyols or amine alcohols while promoting the retention of a large quantity of residual hydroxyl groups through control of the reaction temperatures and stoichiometric ratios. The disclosed reactions may be carried out at relatively low temperatures and with the exclusion of ester catalysts to help ensure that available hydroxyl groups are not consumed though subsequent crosslinking side reactions thereby providing a high hydroxyl value in the resultant compound.

For reactions using polyols and fatty acids, the reaction temperatures may be less than 200° C. Temperatures in excess of 200° C. may promote the formation of ester groups and will significantly decrease the hydroxyl value of the resulting compounds.

For reactions using amine alcohols and fatty acids, the reaction temperatures may be high enough to favor the amide reaction (e.g., about 150° C.) but generally less than reaction temperatures that favor esterification (e.g., more than about 180° C.). Temperatures in excess of 200° C. may promote the formation of ester groups and will significantly decrease the hydroxyl value of the resulting compounds.

Larger molecular weight starting materials (e.g., rosin acids and high molecular weight acids) and ester-based starting materials (e.g., polyesters, vegetable oils, triglycerides, and the like) may require higher reaction temperatures, longer reaction times, or a reaction catalyst to react with the disclosed polyols or amine alcohols as compared to the lower molecular weight fatty acids discussed above.

The second material used that reacts with the one or more carbonyl groups of the first material to increase the number of hydroxyl groups in the reaction product may include polyols, amine alcohols, and the like. Suitable polyols and amine alcohols may include, but are not limited to, polyols containing two or more free hydroxyl groups or amines containing one or more hydroxyl groups including, for example, ethylene glycol, diethylene glycol, triethylene glycol, propylene glycol, dimethylolpropionic acid, glycerine, trimethylolpropane, neopentyl glycol, pentaerythritol, di-pentaerythritol, sorbitol, sucrose, polyethylene glycols, polypropylene glycols, methanolamine, dimethylethanolamine, ethanolamine, aminomethyl propanol, polysulfide polyols, propanolamines, mixtures thereof and the like. In some embodiments, the source for hydroxyl groups may include polyalkylene ether polyols such as a polyethylene glycol (PEG), polytetramethylene ether glycol, polypropylene glycol, or similar ether polyols having a plurality of available hydroxyl groups. Additionally, or alternatively, the source for hydroxyl groups may include a polyalkylene polyol such as polybutadiene diol. In some embodiments the source for hydroxyl groups may include a crude or refined material. For example, the source for hydroxyl groups may be a low cost, pure or impure, side product or waste stream from the manufacture of a higher value product (for example glycerin obtained during the manufacture of ethanol from grains).

Exemplary polyalkylene glycols are miscible, soluble or dispersible in the starting material and include repeating units of ethyl oxide, propyl oxide, or butyl oxides of low to high molecular weight, e.g., having a number average molecular weight of from about 190 to about 8000 g/mol, and preferably greater than about 190 g/mol. Such polyalkylene glycols can include liquids as supplied, for example PEG 300 and PEG 400, respectively available from Dow Chemical Co. as CARBOWAX™ PEG 300 and CARBOWAX PEG 400; waxes; solids; or combinations thereof. Polyethylene polyols represent a preferred class of polyols that when reacted with starting materials such as tall oil provided modified agents exhibiting comparable rejuvenating properties at lower hydroxyl values compared to other polyols tested. Without being bound by theory, it is believed that the long chain polyether linkages of such materials may also help increase the polarity of the resultant anti-aging agents, thereby making the modified anti-aging agent more compatible with the aging asphalt binders and perhaps slowing the agglomeration of the oxidized molecules in the aged binder.

In some examples the disclosed anti-aging agents may be prepared by reacting one or both of the reaction ingredients (e.g., the first material containing the carbonyl groups, the second material that contributes the hydroxyl groups, or both) with a third material (e.g., co-reactant) to produce the anti-aging agent reaction product. The third material may contain one or more unsaturated groups configured to react and join with at least one of the other starting materials in producing the resultant reaction product. The third material may be used to modify the physical properties of the resultant reaction product by, for example, increasing the reaction product's molecular weight, modifying the product's flash point, or helping to reduce manufacturing costs for the reaction product. The third material may or may not include either carbonyl or hydroxyl groups. Materials that may be used for the third material include, but are not limited to, dicyclopentadiene (DCPD), piperylene, isoprene, or an unsaturated alcohol such as a fatty alcohol. For example, starting materials such as soybean oil or tall oil, maleic anhydride, and DCPD may be initially reacted together followed by reaction with one or more polyols or amine alcohols to provide a resultant reaction product having a hydroxyl value of greater than about 25 mg KOH/g. Other usable reactions may include Diels Alder reactions between DCPD, styrene, an unsaturated acid or anhydride; DCPD and vegetable or plant-based oils; vegetable or plant-based oils reacted with maleic anhydride, fumaric acid, adipic acid, neodecanoic acid, or acrylic acid; rosin acid reacted with maleic anhydride; and the like. The reactions may be performed stepwise in the production of the reaction product or as a single reaction scheme.

In some embodiments, the disclosed anti-aging agents can maintain a ΔTc value greater than or equal to −5° C. as the asphalt or asphalt pavement is aged. In some embodiments, the disclosed anti-aging agents can provide an asphalt binder with a ΔTc of greater than or equal to −5° C. after 40 hours of PAV aging at 100° C., or more preferably a ΔTc of greater than or equal to −3° C. In some embodiments, the disclosed anti-aging agents provide an asphalt binder with a more positive ΔTc value and a decreased R-Value following aging, when compared to a similarly-aged asphalt binder without the disclosed anti-aging agents or an aged binder made using similar but unmodified materials or anti-aging agents having lower hydroxyl values.

Additionally, or alternatively, the disclosed modified anti-aging agents can alter, reduce or retard the degradation of rheological properties in binders containing recycled bituminous materials such as RAS and RAP. The disclosed anti-aging agents may be added to asphalt binder mixtures at from about 0.5 to about 15 wt. %, about 1 to about 10 wt. %, or about 1 to about 3 wt. % relative to the total binder amount present.

The disclosed anti-aging agents may be derived from novel materials that have not been previously used as an anti-agents in the asphalt industry but which are modified to possess the disclosed high hydroxyl value (e.g., greater than about 25 mg KOH/g, greater than 35 mg KOH/g, greater than 40 mg KOH/g, or greater than 50 mg KOH/g) and provide the desired ΔTc's disclosed herein. Such novel compounds may include polyols, aliphatic modified polyols, polyester polyols, polycarbonate polyols, or the like.

The disclosed anti-aging agents may be combined with any suitable source of asphalt binder materials. In some embodiments, the asphalt binder mixtures may include virgin asphalt binder, oxidized asphalt binder, asphalt binder extracted from reclaimed asphalt, or combinations thereof. RAS is an attractive component for recycling and reusing because of its high asphalt binder content. RAS may for example have asphalt binder content in the 15 to 35 wt % range, compared to RAP, which may have an asphalt content of about 5 wt %. In general, there are two main types of RAS material including tear-off roofing shingles and roofing shingle tabs (also referred to as manufacturers waste). Tear-off roofing shingles are generated during the demolition or replacement of existing roofs while roofing shingle tabs are generated when new asphalt shingles are trimmed during production to the required physical dimensions. The quality of tear-off roofing shingles can be quite variable due to their environmental exposure. The disclosed anti-aging agents have been shown to improve high and low temperature properties and PG grading for both low and high temperature ends of RAS-containing asphalt binder mixtures such as those produced from tear-off roofing shingles.

As will be recognized by those in the art, the disclosed anti-aging agents may have far reaching uses in the production of asphalt-based materials. The following disclosure focuses primarily on the use of such asphalt binder mixtures in the production of roofing materials (e.g., roofing shingles, roofing rolls, built-up roofing, and the like). However, such asphalt binder mixtures need not be limited to such applications and are envisioned for use in other applications including, but not limited to, asphalt pavement, asphalt pavement maintenance (e.g., asphalt pavement restoration or preservation) products, underlayments, asphalt-based adhesives and sealants, asphalt-based moisture barriers or films, asphalt-based coating materials, and the like.

Roofing materials may include roofing shingles, roll roofing, and built-up roofing. Such roofing materials can be constructed using a substrate material such as a glass fiber mat, an asphalt binder-based coating mixture, and a layer of granules embedded in a top coating. The substrate mat may be impregnated with a hot saturant asphalt binder composition, which is then coated on both sides (e.g., top and bottom) with more asphalt binder and finally surfaced with granules on the top layer. As used herein, the term “top” means the side facing upward or away from the roof when the roofing material is installed on a roof, and “bottom” means the side facing downward or toward the roof.

At least one of the saturant, top, and bottom asphalt coating compositions may be composed of an asphalt binder mixture containing the disclosed anti-aging agents, and the asphalt binder compositions in the different layers need not be the same. Because most of the aging occurs within the top asphalt layer due to the layer being positioned in direct exposure to sunlight, it may be desirable for at least the top asphalt coating compositions to include the disclosed anti-aging additive.

The substrate mat for the roofing material can be any type known for use in reinforcing asphalt binder-based roofing materials including, but not limited to, web, scrim or felt of fibrous materials such as a nonwoven mat of glass fibers, mineral fibers, cellulose fibers, rag fibers, synthetic fibers such as polymer fibers, or mixtures thereof. In some embodiments, the substrate may be an organic material such as a felt mat produced from cellulose fibers, or a glass-based mat produced from glass fibers. In some embodiments the roofing shingles produced are of the organic felt type.

The top surface of the coating asphalt binder may include roofing granules either coated thereon or embedded therein. Roofing granules help contribute to the desired weather-resistance, fire-resistance, visual decorative exterior surface or any combination thereof. In some embodiments, the granules are crushed and screened mineral materials, which are subsequently coated or embedded with the top asphalt binder coating composition. In some embodiments, the granules are hard mineral base rock such as slate, basalt or nephelite. In some embodiments, the granules are the same type of granule, or can be a mixture of different types, textures, shapes, and/or colors of granules. The granules may also include coated granules (e.g., ceramic coatings, infrared reflective coatings, or colored coatings) or additives (e.g., copper compounds). Roofing granule suppliers include 3M, GAF, and Harsco minerals.

Asphalt binder compositions suitable for manufacturing roofing materials are generally produced by selecting a suitable asphalt binder and processing the asphalt binder to obtain properties useful for roofing materials. For example, roofing asphalt binders typically retain some degree of hardness and do not flow under conditions of high temperature generated under sun exposure. Such an increased hardness is generally accompanied by a reduced penetration level, an increased viscosity, and an increased softening point.

In some embodiments, it is desirable to include an aged asphalt binder in the context of roofing applications. Aging the asphalt binder can modify the physical properties of the asphalt binder such as to increase the softening point (e.g., a target softening point of about 85° C. (185° F.) to about 99° C. (210° F.)) and help increase the roofing material's ability to resist flowing at high temperatures on a roof, lower the shingle penetration without becoming too brittle (e.g., target penetration of about 15 dmm), adjust the melt viscosity to within a suitable range, and generally improve the binder's ability to withstand exposure to sun, high temperatures, and inclement weather conditions.

In some embodiments, aging the binder may be performed by an “air blowing” process in which the binder is intentionally oxidized by blowing air through molten asphalt binder for several hours (e.g., about 1 hour to about 72 hours) to modify the physical properties of the asphalt binder such as to increase the asphalt mixture's softening point. The amount of time depends on various factors, such as the type of asphalt binder feedstock used, the processing temperature, the air flow rate, the design of the process equipment, and the desired characteristics of the asphalt binder coating to be produced. Additionally, or alternatively, using binder extracted from RAS or RAP provides a convenient source of aged binder materials for roofing applications.

General specifications for roofing materials are set out in ASTM D225-07 (“Asphalt binder Shingles (Organic Felt) Surfaced into Mineral Granules.” American Society for Testing and Materials, Annual Book of ASTM Standards, Volume 04.04, West Conshohocken, PA, 1996); and ASTM D3462M-19 (“Asphalt binder Shingles Made From Glass Felt and Surfaced with Mineral Granules.” American Society for Testing and Materials, Annual Book of ASTM Standards, Volume 04.04, West Conshohocken, PA, 1996). Additional properties of the roofing asphalt binder compositions may be measured by any suitable test known in the art including, but not limited to: softening point or “SP” by ASTM D36M-14(2020); penetration or “pen” by ASTM D5M-20 run at 25° C.; melt viscosity by ASTM D4402M-15 run at 204° C. (400° F.) with a Model LV Brookfield Viscometer, using a no. 18 spindle, 6 RPM or a Model RV Brookfield Viscometer, using a no. 21 spindle, 50 RPM; durability by ASTM D4798M-11(2019); flashpoint by ASTM D92-18; and stability by ASTM D3791M-11(2018) modified to run at oven temperature of 260° C. (500° F.) for up to 5 days or similar test procedure.

In some embodiments, the asphalt binder compositions configured for producing roofing materials may include a blend of binder materials that include about 75 wt % to about 95 wt % of virgin binder and from about 5 wt % to about 25 wt % of binder extracted from reclaimed asphalt such as RAS. The binder blend may be further processed (e.g., air blown) as desired. Newly manufactured shingles may have a total binder content of about 15 to about 35 wt %, e.g., about 20 wt %.

The disclosed anti-aging agents may be added to the above described asphalt binder mixtures, including those containing aged asphalt binder that is recycled or extracted from RAS or RAP, intentionally oxidized/aged (e.g., air blown) asphalt binder, virgin asphalt binder, or mixtures thereof to produce newly manufactured roofing materials. Addition of the disclosed anti-aging agents to virgin asphalt binder, oxidized asphalt binder, recycled asphalt binder, or combination thereof, and the use of the resulting asphalt binder mixtures used to manufacture one or more of the disclosed roofing materials may alter or inhibit the degradation or rheological properties of aging binders and improve the useful life of the roofing material. For example, the disclosed anti-aging agents may improve the high temperature stiffness, effective temperature range, and low temperature stiffness and/or relaxation properties of the asphalt binders.

The disclosed asphalt binder mixtures may be prepared by heating and mixing or blending the disclosed anti-aging agent, binder sources (e.g., virgin, oxidized, RAS, RAP, or combinations thereof), and other optional additives together to form a mixture. One of skill in the art will recognize that many sequences of adding and mixing components are possible. In one aspect, a method for improving the aging properties of an asphalt binder involves mixing or blending the disclosed anti-aging agent with asphalt binder at a temperature from about 100° C. to about 250° C. In some embodiments, the disclosed anti-aging agent is mixed with the asphalt binder at a temperature from about 125° C. to about 175° C., or 180° C. to 205° C.

In some embodiments, the disclosed asphalt binder compositions may also include other materials (e.g., additives) in addition to disclosed anti-aging agent, for example materials such as antioxidants, adhesion promoters, fillers, polymers, pigments, stabilizers, solvents, waxes, and the like. The types and amounts of such additives will be familiar to persons having ordinary skill in the art. Additives may be chosen based on intended uses (e.g., producing hot applied asphalt membranes), expected environments, performance characteristics, and the like. Useful polymers may include, for example, ethylene-vinyl acetate copolymers, polybutadienes, ethylene-propylene copolymers, ethylene-propylene-diene terpolymers, reactive ethylene terpolymers (e.g., ELVALOY™), butadiene-styrene block copolymers, styrene-butadiene-styrene (SBS) block copolymers, isoprene-styrene block copolymers and styrene-isoprene-styrene (SIS) block copolymers, chloroprene polymers (e.g., neoprenes) and the like. Cured elastomer additives may include ground tire rubber materials. For example, see the 2015 Standard Specifications for the State of California (Section 37, pg. 423), and Section 39 for Hot Mix Asphalt, starting on pg. 447 and available at http://www.dot.ca.gov/distl/dllab/SECTION %2039%20%20HMA.pdf and http://caltrans-opac.ca.gov/publicat.htm.

The disclosed binder compositions also may include one or more fillers in an amount of about 1-80 wt %, 45-60 wt %, 50-75 wt % or 60-80 wt % based on weight of the coating composition. In some embodiments, the filler is particles of sedimentary rocks or minerals such as limestone or calcium carbonate, dolomite, silica, talc, shale, clay, mica, sedimentary rock particles, or combinations thereof. Other suitable fillers include fly ash, carbon black, and inorganic fibers or combinations thereof. The fillers may be included in one or more of the top, bottom, or mat coating layers. In some embodiments, fillers serve to impart desired mechanical properties to a roofing material e.g., the shingles, to reduce raw material costs, or both. The disclosed roofing materials may also include an inorganic or organic agent (e.g., silica sand) on the bottom asphalt coating to aid in packaging and help prevent the individual shingles from sticking together during shipping.

The present application is further illustrated in the following non-limiting examples, in which all parts and percentages are by weight unless otherwise indicated.

### Example 1

Characteristics of bitumen-containing binder in reclaimed asphalt sources relative to virgin binders used in asphalt binder mixtures are shown in Table 1.

TABLE 1

| | | | Critical Low | | Critical Low | | |
|---|---|---|---|---|---|---|---|
| | | 4 mm | temperature | | temperature | 4 mm | |
| | | DSR | grade based | | grade based | DSR m- | |
| | High | S-critical | on 4 mm | | on 4 mm | critical | |
| | temperature | Grade | DSR m-critical | ΔTc ° C., | DSR S-Critical | Grade | ΔTc ° C., |
| Binder & | stiffness | ° C., 20 | Grade ° C. | 20 hr. | Grade ° C., | ° C. 40 | 40 hr. |
| source | grade, ° C. | hr. PAV | 20 hr. PAV | PAV | 40 hr. PAV | hr. PAV | PAV |
| PG 58-28 | 60.3 | −31.4 | −30.9 | −0.5 | −30.7 | −27.8 | −2.9 |
| PG 64-22 | 67.1 | −27.1 | −26.2 | −.9 | −25.8 | −23.2 | −2.6 |
| Binder | | 4 mm DSR | Critical Low | ΔTc ° C. | | | |
| recovered | | S-critical | temperature | | | | |
| from RAP | | Grade | creep grade | | | | |
| or RAS | | | based on 4 | | | | |
| | | | mm DSR | | | | |
| | | | m-critical | | | | |
| | | | grade | | | | |
| RAP 03-16-15-D | 85.0 | −25.5 | −22.3 | −3.2 | | | |
| RAP 02-23-15-B | 89.5 | −25.3 | −21.3 | −4.0 | | | |
| RAP 03-24-15-D | 98.8 | −22.4 | −17.1 | −5.3 | | | |
| RAP 02-09-15-B | 87.5 | −27.8 | −26.2 | −1.6 | | | |
| RAS 04-03-15-D | 158.2 | −27.5 | −0.3 | −27.2 | | | |
| RAS 02-09-15-C | 137.7 | −25.7 | +9.7 | −35.4 | | | |

The data in Table 1 show typical virgin binders produced at refineries can maintain a ΔTc of greater than −3° C. after 40 hours of PAV aging. Further, the data in Table 1 show that binder recovered from RAP can have ΔTc values of less than −4° C., and that the impact of high RAP levels in new bituminous mixtures can further decrease the ΔTc values. Further, the extremely negative values of ΔTc for RAS recovered binders require additional scrutiny as to the overall impact of RAS incorporation into bituminous mixtures.

RAS asphalt binder typically is highly oxidized and very stiff; therefore, RAS is expected to impact ΔTc to a higher degree than experienced with RAP asphalt binder. Calculations of the ΔTc of RAS asphalt binder may be more complicated to that for RAP asphalt binder due to the difficulty of BBR analysis. The table below presents estimated ΔTc data from RAS binders from the National Center for Asphalt Technology (NCAT) Report 16-01 as reported in TRB E-Circular 241and additional data from AI IS 240.

TABLE 2
Estimated ΔTc of RAS Binder

| RAS Source | T_{c} High | T_{c} Low | ΔTc |
|---|---|---|---|
| New Hampshire | 163.0 | 12.0 | −33.0 |
| Oregon | 152.0 | 14.0 | −37.0 |
| Texas | 122.0 | −7.0 | −23.0 |
| Wisconsin | 146.0 | 16.0 | −40.0 |

### Example 2

Preparation of crude tall oil modified anti-aging agent: Two representative modified anti-aging agents were prepared using crude tall oil and either PEG 400 or glycerin as the source of hydroxyl groups.

Sample #1 was prepared using 680 grams of crude tall oil having an acid number of approximately 160 and a hydroxyl number of approximately 1 mg KOH/g as determined by ASTM D1957-86 (1995). The crude tall oil was heated to approximately 70° C. to facilitate mixing, followed by adding approximately 320 grams of PEG 400 (Polyethylene ether glycol with molecular weight of 400 g/mole). The contents of the flask were heated to an elevated temperature of 180° C. to initiate a minor level of esterification reaction (viz., partial esterification) to join the PEG to the tall oil compounds but prevent the hydroxyl groups from being fully consumed in the reaction. Further, no esterification catalyst was used in the reaction in order to limit the extent of esterification that occurred. The reaction was held at the elevated temperature until an acid number of 65-85 is obtained. The resulting modified anti-aging agent had a hydroxyl value of approximately 35-60 mg KOH/g sample, and is a partial ester.

Sample #2 was prepared using 785 grams of crude tall oil having an acid number of approximately 160 and a hydroxyl number of approximately 1 mg KOH/g as determined by ASTM D1957-86 (1995). The crude tall oil was heated to approximately 70° C. to facilitate mixing, followed by adding approximately 215 grams of glycerin. The contents of the flask were heated to an elevated temperature of 180° C. to initiate a minor level of esterification reaction to join the glycerin to the tall oil compounds. No esterification catalyst was used in the reaction in order to limit the extent of esterification that occurred. The reaction was held at the elevated temperature until an acid number of 50-70 was obtained. Based on the stoichiometry and reaction conditions, the glycerin was expected to combine with tall oil such that only about 1-1.25 of the 3 glycerin hydroxyl groups reacted allowing about 1.75-2.0 of the hydroxyl groups to remain free. The resulting modified anti-aging agent had a hydroxyl value of approximately 45-75 mg KOH/g.

### Example 3

To investigate the efficacy of the modified anti-aging agents of Example 2, five asphalt binders were produced and aged tested under various conditions. The binders were produced by mixing the components with a low shear LIGHTING™ mixer in a 1 gallon can at a temperature of 187.8° C.-204° C. (370-400° F.) for approximately 30 minutes.

Binder #1 consisted of only virgin binder PG64-22.

Binder #2 included 96% PG64-22 blended with 4% of the Sample #1 modified anti-aging agent.

Binder #3 included 92% PG64-22 blended with 8% of the Sample #1 modified anti-aging agent.

Binder #4 included 96% PG64-22 blended with 4% of the Sample #2 modified anti-aging agent.

Binder #5 included 92% PG64-22 blended with 8% of the Sample #2 modified anti-aging agent.

The high and low temperature properties of the resultant binders were measured using the 4 mm DSR test procedure for unaged, RTFO aged samples according to AASHTO T-240, and samples PAV aged for 20 hrs. at 100° C. according to AASHTO R28. The results are shown in Table 3.

TABLE 3

| | AASHTO | Test | | Binder | Binder | Binder | Binder | Binder |
|---|---|---|---|---|---|---|---|---|
| Properties | Method | Temp. | | 1 | 2 | 3 | 4 | 5 |
| Penetration, 100 | T-49 | 25° | C. | 64 | 121 | 240 | 111 | 16 |
| g, 5 sec, dmm | | | | | | | | |
| Rotational | T-316 | 135° | C. | 0.398 | 0.285 | 0.209 | 0.29 | 0.221 |
| Viscosity, 3.00 | | | | | | | | |
| Pa · s maximum. | | | | | | | | |
| Values in Pa · s | | | | | | | | |
| Unaged DSR, | T-315 | 52° | C. | — | 3.15 | 1.44 | 3.63 | 1.98 |
| G*/Sin(delta), | | 58° | C. | — | 1.37 | 0.656 | 1.55 | 0.868 |
| Values in kPa | | 64° | C. | 1.32 | 0.636 | — | 0.715 | — |
| (specification | | 70° | C. | 0.617 | — | — | — | — |
| min. 1.00 kPa) | | 76° | C. | — | — | — | — | — |
| | | Pass/fail | | 66.2 | 60.4 | 54.8 | 61.4 | 57 |
| | | (P/F) Temp. | | | | | | |
| RTFO Mass | T-240 | | | −0.024 | −0.396 | −0.637 | −0.282 | −0.417 |
| loss (%) | | | | | | | | |
| RTFO DSR, | T-315 | 52° | C. | — | 8.8 | 4 | 9.09 | 4.6 |
| G*/Sin(delta), | | 58° | C. | — | 3.73 | 1.76 | 3.82 | 2.01 |
| Values in kPa | | 64° | C. | 3.48 | 1.66 | — | 1.7 | — |
| (specification | | 70° | C. | 1.56 | — | — | — | — |
| min. 1.00 kPa) | | 76° | C. | — | — | — | — | — |
| | | P/F Temp. | | 67.4 | 61.9 | 56.4 | 62.1 | 57.3 |
| PAV DSR, | T-315 | 28° | C. | — | — | — | — | — |
| G*/Sin(delta), | | 25° | C. | 4250 | 2350 | 1160 | 2570 | 1440 |
| Values in kPa | | 22° | C. | 6260 | 3640 | 1870 | 3990 | 2320 |
| (specification | | 19° | C. | — | 5490 | 2960 | 6010 | 3670 |
| max 5000 kPa) | | 16° | C. | — | — | 4610 | — | 5700 |
| | | 13° | C. | — | — | 7020 | — | — |

| | | | | | |
|---|---|---|---|---|---|
| P/F Temp. | 23.7 | 19.7 | 15.4 | 20.3 | 16.9 |

| | | | | | |
|---|---|---|---|---|---|
| Aging Index | 2.63 | 2.72 | 2.78 | 2.46 | 2.32 |
| (Passing RTFO/Unaged DSR values) | | | | | |

The P/F temperature for the heated binders in the unaged condition is the temperature at which the binder stiffhess equals approximately 1 kiloPascal (kPa) when tested in accordance with AASHTO T-315. The P/F temperature for binders in the RFTO aged conditions is the heated temperature at which the binder stiffhess equals approximately 2.2 kPa when tested in accordance with AASHTO T-315. The P/F temperature for binders in the RFTO aged conditions is the low temperature at which the binder stiffness equals approximately 5000 kPa when tested in accordance with AASHTO T-315. The results in Table 3 show that when no anti-aging agent is present in the sample the P/F temperature increases at a faster rate than when the modified anti-aging agent is present.

The ΔTc values were also measured using low temperature BBR testing according to AASHTO T-313 for PAV aged samples aged at 20 and 40 hrs. at 100*C. The results for 20 and 40 hrs. aged samples are shown in Tables 4 and 5 respectively.

TABLE 4

| Properties PAV 20 hrs. at 100° | Test | | Binder | Binder | Binder | Binder | Binder |
|---|---|---|---|---|---|---|---|
| C., 300 psi | Temp. | | 1 | 2 | 3 | 4 | 5 |
| Stiffness @ 60 sec., Values | −6° | C. | — | — | — | — | — |
| in MPa (specification max 300) | | | | | | | |
| m-value @ 60 sec Values | | | — | — | — | — | — |
| in MPa/s (specification min. 0.3) | | | | | | | |
| Stiffness @ 60 sec., Values | −12° | C. | 198 | 136 | — | 141 | — |
| in MPa (specification max 300) | | | | | | | |
| m-value @ 60 sec Values | | | 0.325 | 0.378 | — | 0.368 | — |
| in MPa/s (specification min. 0.3) | | | | | | | |
| Stiffness @ 60 sec., Values | −18° | C. | 392 | 304 | 200 | 325 | 238 |
| in MPa (specification max 300) | | | | | | | |
| m-value @ 60 sec Values | | | 0.267 | 0.306 | 0.363 | 0.303 | 0.336 |
| in MPa/s (specification min. 0.3) | | | | | | | |
| Stiffness @ 60 sec., Values | −24° | C. | — | 591 | 447 | 640 | 518 |

| | | | | | |
|---|---|---|---|---|---|
| in MPa (specification max 300) | | | | | |
| m-value @ 60 sec Values | — | 0.244 | 0.288 | 0.236 | 0.269 |
| in MPa/s (specification min. 0.3) | | | | | |

| | | | | | |
|---|---|---|---|---|---|
| S-critical Temperature (° C.) | −15.7 | −17.9 | −21 | −17.4 | −19.8 |
| M-critical Temperature (° C.) | −14.6 | −18.6 | −23 | −18.3 | −21.2 |
| ΔTc for 20-hour PAV data | −1.1 | 0.7 | 2 | 0.9 | 1.4 |

TABLE 5

| Properties PAV 40 hrs. at 100° | Test | | Binder | Binder | Binder | Binder | Binder |
|---|---|---|---|---|---|---|---|
| C., 300 psi | Temp. | | 1 | 2 | 3 | 4 | 5 |
| Stiffness @ 60 sec., Values | −6° | C. | 123 | — | — | — | — |
| in MPa (specification max 300) | | | | | | | |
| m-value @ 60 sec Values | | | 0.329 | — | — | — | — |
| in MPa/s (specification min. 0.3) | | | | | | | |
| Stiffness @ 60 sec., Values | −12° | C. | 235 | 167 | — | 185 | 136 |
| in MPa (specification max 300) | | | | | | | |
| m-value @ 60 sec Values | | | 0.289 | 0.33 | — | 0.32 | 0.357 |
| in MPa/s (specification min. 0.3) | | | | | | | |
| Stiffness @ 60 sec., Values | −18° | C. | — | 328 | 245 | 381 | 306 |
| in MPa (specification max 300) | | | | | | | |
| m-value @ 60 sec Values | | | — | 0.277 | 0.318 | 0.265 | 0.286 |
| in MPa/s (specification min. 0.3) | | | | | | | |
| Stiffness @ 60 sec., Values | −24° | C. | — | — | 515 | — | — |

| | | | | | |
|---|---|---|---|---|---|
| in MPa (specification max 300) | | | | | |
| m-value @ 60 sec Values | — | — | 0.26 | — | — |
| in MPa/s (specification min. 0.3) | | | | | |

| | | | | | |
|---|---|---|---|---|---|
| S-critical Temperature (° C.) | −14.3 | −17.2 | −19.6 | −16 | −15.7 |
| M-critical Temperature (° C.) | −10.4 | −15.4 | −19.9 | −14.2 | −14.6 |
| ΔTc for 40-hour PAV data | −3.9 | −1.8 | 0.3 | −1.8 | −1.1 |

For Binder #1 which did not include the presence of an anti-aging agent, the low temperature ΔTc under the BBR tests was comparatively less than any of the sample binders that included the Sample #1 or #2 modified anti-aging agents. All the binder samples that included the tested modified anti-aging agents exhibited a more positive ΔTc. All the ΔTc values for the 20 hrs. PAV aged binder samples with modified anti-aging agents were positive compared to pure PG64-22 which exhibited a ΔTc of −1.1. The ΔTc values for the 40 hrs. PAV aged binder samples with modified anti-aging agents likewise showed superiority over pure PG64-22 which had a ΔTc of −3.9 compared to the lowest ΔTc of −1.8 for the binder samples with modified anti-aging agents.

The data summarized in Tables 3-5 shows that the modified anti-aging agents with a high hydroxyl value had significant favorable impact on both softness and the critical relaxation property related to the in-value for aged binder samples.

### Example 4

Preparation of soybean oil as a modified anti-aging agent through an alcoholysis-transesterification reaction: Approximately 800 grams of soybean oil is added to a lab flask. The flask is heated to approximately 70° C. to facilitate mixing. Approximately 100 grams of glycerin and 5 grams of a transesterification catalyst (lithium ricinoleate) are then added to the flask. The contents of the flask are heated to approximately 250° C. for 2 hours and then heated to approximately 270° C. and held for 10 hours. The material is then steam sparged to remove any unreacted glycerin. The resulting compound has a hydroxyl value of greater than 100 mg KOH/g sample.

### Example 5

Preparation of tall oil modified anti-aging agent with amine alcohol: Approximately 800 grams of the Sample #2 material having a hydroxyl value of 45-75 mg KOH/g is added to a lab flask and heated to approximately 70° C. to facilitate mixing. Approximately 20 grams of monoethanolamine is added to the flask. The contents of the flask are heated to about 140° C. and held 2 hours to promote amide formation. The resultant material is then steam sparged to remove any unreacted monoethanolamine. The lower temperature of the reaction promotes amide formation while minimizing ester formation and thus preserving the hydroxyl groups. The resulting compound has a hydroxyl value of greater than 50 mg KOH/g.

### Example 6

Preparation of tall oil modified anti-aging agent with amine alcohol: Approximately 800 grams of crude tall oil having an acid number of about 160 are added to a lab flask. The flask is heated to 70° C. to facilitate mixing followed by the addition of approximately 100 grams of monoethanolamine. The contents of the flask are heated to 140° C. and held 3 hours to promote amide formation. The material is then steam sparged to remove any unreacted monoethanolamine. The lower temperature of the reaction promotes the amide formation while minimizing ester formation and thus preserving the hydroxyl groups. The resulting compound has an acid number of about 60-90 and a hydroxyl value of greater than 65 mg KOH/g.

### Example 7

Preparation of tall oil modified anti-aging agent with a polyol: Approximately 785 grams of crude tall oil having an acid number of about 160 and a hydroxyl number of approximately 1 are added to a lab flask and heated to approximately 70° C. to facilitate mixing. Approximately 24 grams of maleic anhydride are added to the flask. The contents of the flask are heated to about 205° C. and held for 2.5 hours to facilitate the formation of a Diels-Alder adduct. The contents of the flask is then cooled to about 180° C. followed by the addition of approximately 235 grams of glycerin to initiate a minor level of esterification reaction to join the glycerin to the tall oil adducts but prevent the hydroxyl groups from being fully consumed in the reaction. This temperature will initiate a small level of esterification reaction while also preserving the final hydroxyl content. Further, no esterification catalyst is used in the reaction in order to limit the extent of esterification that occurred. The reaction is held at the elevated temperature until an acid number of 70-90 is obtained. The resulting sample modified anti-aging agent has a hydroxyl value of approximately 60-95 mg KOH/g sample.

### Example 8

Preparation of tall oil modified anti-aging agent with a polyol: Approximately 785 grams of crude tall oil having an acid number of about 160 and a hydroxyl number of approximately 1 are added to a lab flask and heated to approximately 70° C. to facilitate mixing. Approximately 315 grams of glycerin are added. The contents of the flask are heated to an elevated temperature of 180° C. and held for about 1.5 hours. The reaction mass is then heated to about 235° C. and held for 1 hour. The reaction mass is then heated to 270° C. and held until the acid number is less than about 10. The resulting sample modified anti-aging agent has a hydroxyl value of approximately 60-100 mg KOH/g sample.

### Example 9

Preparation of soybean oil modified anti-aging agent: A mixture of soybean oil and glycerine is reacted to create an initial reaction product. The initial reaction product is then further reacted with rosin acid at about 235° C. and held for 1 hour. The reaction mass is then heated to 250-280° C. and held until the acid number is less than about 10. The resulting sample modified anti-aging agent has a hydroxyl value of approximately 60-100 mg KOH/g sample.

The starting materials, polyols, and amine alcohols for any of the above examples of modified anti-aging agents may be substituted to include any material in accordance with the techniques disclosed herein. Additionally, any of the above example techniques may be changed or combined with other examples or techniques described herein.

### Comparative Example 1

Tall oil pitch: Experiments were conducted relating to PG 64-22 blends that included 5 or 10% unmodified tall oil pitch. The tall oil pitch was obtained from Union Camp under the trade name Tallex, and is no longer commercially available. The sample blends were produced and aged for 20 and 40 hours in the PAV following ASTM D65217.

Binder #6 included 95% PG 64-22 plus 5% tall oil pitch.

Binder #7 included 90% PG 64-22 plus 10% tall oil pitch.

The Binder blends were produced by mixing the components with a low shear LIGHTNIN mixer in a 1 gallon can at a temperature of 187.8° C.-204° C. (370-400° F.) for approximately 30 minutes.

4 mm DSR testing was conducted at the aging conditions shown below to determine the S-critical and M-critical low temperature grades of the blends at the different aging conditions. ΔTc, which is obtained by subtracting the M-critical low temperature value from the S-critical low temperature value was determined at each aging conditions.

TABLE 6

| | | S-critical | M-critical | |
|---|---|---|---|---|
| Binder | | Temperature | Temperature | |
| Aging | Binder | (° C.) | (° C.) | ΔTc |
| Unaged | PG 64-22 | −30.51 | −32.72 | 2.21 |
| Unaged | Binder 6 | −31.81 | −34.88 | 3.07 |
| Unaged | Binder 7 | −32.75 | −34.81 | 2.06 |
| 20 hr. PAV | PG 64-22 | −24.91 | −23.99 | −0.92 |
| 20 hr. PAV | Binder 6 | −25.346 | −25.5 | 0.16 |
| 20 hr. PAV | Binder 7 | −26.48 | −25.90 | −0.58 |
| 40 hr. PAV | PG 64-22 | −23.66 | −22.24 | −1.42 |
| 40 hr. PAV | Binder 6 | −23.952 | −22.0 | −2.00 |
| 40 hr. PAV | Binder 7 | −25.76 | −23.25 | −2.51 |

The data from Table 5 shows that the unmodified tall oil pitch in Binders #6 and 7 failed to improve the ΔTc (e.g., provide a more positive ΔTc) in the 40 hour PAV aged samples compared to PG 64-22 with no additive.

Having thus described preferred embodiments of the disclosed compounds, compositions and methods, those of skill in the art will readily appreciate that the teachings found herein may be applied to yet other embodiments within the scope of the claims hereto attached. The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. An asphalt-containing material comprising:
an asphalt binder composition comprising:
an asphalt binder comprising at least one of a virgin asphalt binder, an air-blown virgin asphalt binder, a reclaimed asphalt binder material comprising asphalt pavement (RAP), or a reclaimed asphalt binder material comprising asphalt shingles (RAS); and
an anti-aging agent that is a reaction product of ingredients including (i) a first material comprising a compound containing one or more carbonyl groups and (ii) a second material that reacts with the one or more carbonyl groups of the first material and adds hydroxyl groups to the reaction product, wherein the anti-aging agent has a hydroxyl value of greater than about 25 mg KOH/g.

2. The asphalt-containing material of claim 1, wherein the asphalt binder composition is a hot applied asphalt membrane that provides a moisture barrier.

3. The asphalt-containing material of claim 1 or 2, wherein the asphalt-containing material is a moisture barrier or waterproof film, an underlayment, an asphalt-based adhesive or sealant, a roofing material, or asphalt pavement comprising the asphalt binder composition.

4. The asphalt-containing material of claim 4, wherein the article is a roofing material comprising a roofing substrate coated or saturated with the asphalt binder composition.

5. A method for slowing the aging effects of an asphalt-containing material comprising:
forming an asphalt binder composition by adding an anti-aging agent to an asphalt binder, wherein the asphalt binder comprises at least one of a virgin asphalt binder, an air-blown virgin asphalt binder, a reclaimed asphalt binder material comprising asphalt pavement (RAP) or a reclaimed asphalt binder material comprising asphalt shingles (RAS); and wherein the anti-aging agent is a reaction product of ingredients including (i) a first material comprising a compound containing one or more carbonyl groups and (ii) a second material that reacts with the one or more carbonyl groups of the first material and adds hydroxyl groups to the reaction product, wherein the anti-aging agent has a hydroxyl value of greater than about 25 mg KOH/g.

6. The method of claim 5, further comprising producing a moisture barrier, a waterproof film, an underlayment, an asphalt-based adhesive or sealants, a roofing material, or asphalt pavement containing the asphalt binder composition.

7. The method of claim 7, further comprising coating or saturating a roofing substrate with the asphalt binder composition to produce a roofing material.

8. The asphalt-containing material of claim 4 or the method of claim 7, wherein the roofing substrate comprises a fibrous mat.

9. The asphalt-containing material or the method claim 8, further comprising a roofing aggregate applied to at least one surface of the roofing material.

10. The asphalt-containing material or the method of any one of the proceeding claims, wherein the one or more carbonyl groups of the first material include one or more carboxylic acid groups, anhydride, ester groups, amide groups, or imide groups.

11. The asphalt-containing material or the method of any one of the proceeding claims, wherein the first material comprises one or more plant-based materials, rosin acids, or fatty acids.

12. The asphalt-containing material or the method of any one of the proceeding claims, wherein the first material comprises one or more of castor oil, cashew nut shell oil, cottonseed oil, corn oil, peanut oil, rapeseed oil, rice bran oil, safflower oil, sarsaparilla root oil, soybean oil, sunflower oil, tall oil, vegetable oil, and wheat germ oil.

13. The asphalt-containing material or the method of any one of the proceeding claims, wherein the first material comprises at least one of a C₁-C₃₆ carboxylic acid, a dicarboxylic acid, an anhydride, a keto acid, a compound containing both carboxylic acid and anhydride groups, or a tricarboxylic acid.

14. The asphalt-containing material or the method of any one of the proceeding claims, wherein the first material comprises at least one of tall oil, crude tall oil, or tall oil pitch.

15. The asphalt-containing material or the method of any one of the proceeding claims, wherein the first material comprises a coal-based material or a petroleum-based material.

16. The asphalt-containing material or the method of any one of the proceeding claims, wherein the anti-aging agent is a reaction product of ingredients further including iii) a third material comprising an unsaturated group that reacts with at least one of the first material or the second material in forming the reaction product.

17. The asphalt-containing material or the method of claim 16, wherein the third material comprises at least one of DCPD, piperylene, isoprene, or an unsaturated alcohol.

18. The asphalt-containing material or the method of any one of the proceeding claims, wherein the second material comprises a polyol, an amine alcohol, or combination thereof.

19. The asphalt-containing material or the method of any one of the proceeding claims, wherein the second material comprises one or more of ethylene glycol, diethylene glycol, triethylene glycol, propylene glycol, dimethylolpropionic acid, glycerine, trimethylolpropane, neopentyl glycol, pentaerythritol, di-pentaerythritol, sorbitol, sucrose, polyethylene glycols, polypropylene glycols, methanolamine, dimethylethanolamine, ethanolamine, aminomethyl propanol, polysulfide polyols, or propanolamines.

20. The asphalt-containing material or the method of any one of the proceeding claims, wherein the second material comprises at least one of polyalkylene ether polyols or polyalkylene polyols.

21. The asphalt-containing material or the method of claim 20, wherein the second material comprises polyethylene glycol, polytetramethylene ether glycol, or polypropylene glycol

22. The asphalt-containing material or the method of claim 20, wherein the second material comprises polybutadiene diol.

23. The asphalt-containing material or the method of any one of the proceeding claims, wherein the anti-aging agent has a hydroxyl value of greater than about 35 mg KOH/g.

24. The asphalt-containing material or the method of any one of the proceeding claims, wherein the anti-aging agent has a hydroxyl value of greater than about 50 mg KOH/g.

25. The asphalt-containing material or the method of any one of the proceeding claims, wherein the anti-aging agent has an acid value of less than about 100.

26. The asphalt-containing material or the method of any one of the proceeding claims, wherein the asphalt binder mixed with the anti-aging agent provides a ΔTc of greater than or equal to −5.0° C. after 40 hours of PAV aging at 100° C.

27. The asphalt-containing material or the method of any one of the proceeding claims, wherein the asphalt binder mixed with the anti-aging agent provides a ΔTc of greater than or equal to −3.0° C. after 40 hours of PAV aging at 100° C.

28. The asphalt-containing material or the method of any one of the proceeding claims, wherein the anti-aging agent is present in an effective amount to provide a more positive ΔTc value after 40 hours of PAV aging at 100° C. compared to a similarly-aged binder without the anti-aging agent.

29. The asphalt-containing material or the method of any one of the proceeding claims, wherein the asphalt binder composition comprises about 0.5 percent by weight (wt. %) to about 15 wt. % of the anti-aging agent relative to the asphalt binder.

30. The asphalt-containing material or the method of any one of the proceeding claims, wherein the asphalt binder comprises the reclaimed asphalt binder material comprising reclaimed asphalt pavement.

31. The asphalt-containing material or the method of any one of the proceeding claims, wherein the anti-aging agent includes ingredients derived from reacting the first material comprising a carboxylic acid at a temperature of less than about 200° C. with the second material comprising one or more polyols or amine alcohols to increase a hydroxyl value of the first material.

32. The asphalt-containing material or the method of any one of the proceeding claims, wherein the anti-aging agent includes ingredients derived from reacting the first material comprising an ester group at a temperature of greater than about 200° C. with the second material comprising one or more polyols or amine alcohols to increase a hydroxyl value of the first material.

33. The asphalt-containing material or the method of any one of the proceeding claims, wherein the asphalt binder comprises RAS.

34. An asphalt binder composition for use in producing a moisture barrier, a waterproof film, an underlayment, an asphalt-based adhesive or sealants, a roofing material, or asphalt pavement, the asphalt binder composition comprising:
an asphalt binder comprising at least one of a virgin asphalt binder, an air-blown virgin asphalt binder, a reclaimed asphalt binder material comprising asphalt pavement (RAP), or a reclaimed asphalt binder material comprising asphalt shingles (RAS); and
an anti-aging agent derived from reacting an asphalt additive with one or more polyols or amine alcohols to increase a hydroxyl value of the additive, wherein the anti-aging agent provides a less negative ΔTc in aged asphalt containing the modified anti-aging agent after 40 hours of PAV aging at 100° C. compared to a similarly-aged binder with the unmodified asphalt additive.

35. The asphalt binder composition of claim 31, wherein the anti-aging agent has a hydroxyl value of greater than about 25 mg KOH/g and the additive has a hydroxyl value of less than about 25 mg KOH/g prior to being reacted with the one or more polyols or amine alcohols.
